(19) United States
(12) Patent Application Publication
(10) Pub. No.: US 2020/0031284 A1
(43) Pub. Date: Jan. 30, 2020

(54) Trailer Cargo Monitoring Apparatus for a Vehicle

(71) Applicant: Continental Automotive GmbH, Hannover (DE)

(72) Inventor: Dan ONICA, Giroc (RO)

(21) Appl. No.: 16/365,818

(22) Filed: Mar. 27, 2019

(30) Foreign Application Priority Data
Jul. 27, 2018 (EP) 18465551

(51) Int. Cl. B60R 1/00; G06T 7/70

(52) U.S. Cl. CPC B60R 1/002; B60R 2300/8006; G06T 2207/30252; G06T 7/70

(57) ABSTRACT

A trailer cargo monitoring apparatus (1) for a vehicle (2) includes a sensor arrangement (20) and a calculation unit (10). The sensor arrangement (20) is configured to capture image data of a cargo (31) on or within a trailer (3) coupled to the vehicle (2). The calculation unit (10) is configured to analyze the captured image data and therefrom to determine an actual position of the cargo (31) to monitor the cargo (31). The calculation unit (10) is further configured to inform the driver of the vehicle (2), when the actual position of the cargo (31) differs from a predefined position by more than a predefined threshold.

### FIELD OF THE INVENTION

The invention relates to a trailer cargo monitoring apparatus, a vehicle comprising the trailer cargo monitoring apparatus, a method for monitoring the cargo on or within the trailer, a computer program element and a computer-readable medium.

### BACKGROUND INFORMATION

Driving with a trailer may sometimes be exhausting and stressful for the driver, for example, if the driver is not used to driving with the trailer or if he or she is driving in urban areas with heavy traffic. It is also particularly burdensome for the driver to have to continuously or repeatedly monitor a cargo on the trailer to ensure that the cargo is and remains properly positioned and secured on the trailer. If a cargo is positioned improperly or shifts to an improper position on the trailer during transport, it can cause a hazardous situation for the subject vehicle and for other traffic participants.

### SUMMARY OF THE INVENTION

It is an object of at least one of the embodiments or aspects of the present invention to increase safety in traffic, especially relating to safe positioning of a cargo on a trailer.

The above object can be achieved by at least one embodiment or aspect of the present invention as set forth herein. The attainment of this object is, however, not a required limitation of the claimed invention.

A first aspect of the invention is related to a trailer cargo monitoring apparatus for a vehicle. The trailer cargo monitoring apparatus comprises a sensor arrangement and a calculation unit, such as a processing circuit or processor. The sensor arrangement is configured to capture image data of a cargo within a trailer, wherein the trailer is coupled to the vehicle. The calculation unit is configured to analyze the captured image data and to determine an actual position of the cargo to monitor the cargo. The calculation unit is further configured to inform the driver of the vehicle, if the actual position of the cargo differs from a predefined position by more than a predefined threshold.

This may lead to increased safety. The sensor arrangement may comprise a camera, for example the rear view camera of the vehicle for capturing image data of the cargo. The sensor arrangement may capture image data of the trailer and cargo within the trailer, i.e. on a cargo area or platform of the trailer. The calculation unit may analyze the captured image data and determine the position of the cargo within the trailer to monitor the cargo. The calculation unit may compare the actual position of the cargo with a predefined position of the cargo based on the captured image data. Alternatively or in addition, the predefined position may be a reference position, which is defined and stored in a memory before the vehicle starts driving. Further, the calculation unit may inform or warn the driver, if the actual position of the cargo differs from the predefined position of the cargo by more than a predefined threshold. In other words, if the cargo has moved or the position of the cargo has shifted, the position shift may be determined by the calculation unit by comparing with the predefined position of the cargo. Furthermore, if the position shift or the difference in position exceeds the predefined threshold, for example 5, 10 or 15 cm, the driver gets informed or receives a warning. Informing the driver may also be a warning via an indication light, e.g. in the dashboard, or via a display screen or via a user interface.

It should be understood that the term cargo refers to any object or objects on the cargo area or platform of the trailer or within the trailer. For example the cargo may be an item of furniture, e.g. a couch, or building materials, e.g. cement, or a bike. The cargo may be secured by belts or just placed loose on the cargo platform. Alternatively or in addition, the cargo may comprise a plurality of different objects. In this case all of the different objects may be monitored by the trailer cargo monitoring apparatus.

The actual position of the cargo may have changed due to a driving maneuver, such as braking or driving around a corner. If objects or parts of the cargo fall off the trailer, this may be monitored by the trailer cargo monitoring apparatus. The trailer cargo monitoring apparatus is also configured to inform the driver of a change in the position or a change in the state of the cargo. For example, if a position shift of the cargo takes place, the driver is notified so that he or she may rearrange the cargo or may secure the cargo more thoroughly.

The calculation unit may comprise a processor and/or a calculation circuit. Further, the calculation unit may comprise a memory or storage unit.

It should be noted, that the calculation unit may be configured to detect whether a trailer is coupled to the vehicle and whether this trailer carries a cargo to be monitored. If no trailer or no cargo is detected, then the trailer cargo monitoring apparatus may be turned off.

According to an embodiment, the sensor arrangement is arranged at a rear end of the vehicle facing in the direction of the trailer. It should be understood, that the viewing angle of the sensor arrangement should be configured to monitor the cargo of the trailer. Preferably, the sensor arrangement is arranged at a higher position on the vehicle, for example in a spoiler.

According to a further embodiment, the sensor arrangement is configured to capture reference image data of the cargo within the trailer before the vehicle starts driving, and the calculation unit is configured to determine a position shift of the cargo by comparing the image data captured by the sensor arrangement later during driving, with the reference image data.

The reference image data may be captured before the vehicle starts driving. The start of driving may be detected if the velocity of the vehicle becomes greater than 2 m/s. The reference image may be stored on a memory device of the trailer cargo monitoring apparatus. Further, this reference image data may be captured before each trip or start of the vehicle to have actual reference data.

According to an embodiment, the sensor arrangement comprises a camera. The sensor arrangement may further comprise a radar, a lidar or an ultrasonic sensor for capturing corresponding image data of the cargo within or on the trailer.

According to an embodiment, the trailer is an open trailer. It should be understood that the trailer cargo monitoring apparatus works in particular with open trailers, wherein the cargo can be seen from the rear portion of the vehicle. Open trailer refers to a trailer without a cover or an installation covering the cargo on the cargo platform of the trailer. Alternatively, the cargo monitoring apparatus or a sensor thereof must be installed in an enclosed trailer or otherwise to be able to monitor the cargo within an enclosed trailer. Throughout this application, the terms “on the trailer” and “within the trailer” are intended to mean essentially the same thing (cargo being carried by the trailer) unless specifically excluded.

According to a further embodiment, the calculation unit is configured to inform the driver of the vehicle via an indication lamp and/or via a user interface, if the position shift exceeds the predefined threshold, wherein the predefined threshold may be 5, 10 or 15 cm.

According to yet another aspect of the invention, there is provided a vehicle comprising the trailer cargo monitoring apparatus disclosed herein.

The vehicle may, for example, be a motor vehicle, such as a car, bus or truck.

A further aspect of the invention provides a method for monitoring a cargo of a trailer, comprising the steps of:
Capturing, by a sensor arrangement, image data of the cargo within or on the trailer;
Analyzing, by a calculation unit, the captured image data;
Determining, by the calculation unit, an actual position of the cargo to monitor the cargo; and
Informing, by the calculation unit, the driver of the vehicle if the actual position of the cargo differs from a predefined position by more than a predefined threshold.

According to another aspect of the invention, there is provided a computer program element for controlling the trailer cargo monitoring apparatus as previously described which, when the computer program element is executed by the calculation unit or by a processing unit, is adapted to perform the method steps as previously described.

There is also provided a computer readable medium which stores thereon the computer element as previously described.

Advantageously, the benefits provided by any of the above aspects equally apply to all of the other aspects and vice versa.

The above aspects and examples will become apparent from and be elucidated with reference to the embodiments described hereinafter.

### BRIEF DESCRIPTION OF THE DRAWINGS

Exemplary embodiments of the invention will be described in the following with reference to the following drawings, wherein:

FIG. 1 shows a block diagram of a trailer cargo monitoring apparatus according to an embodiment;

FIG. 2 shows a schematic view of a vehicle with a trailer cargo monitoring apparatus towing a trailer according to an embodiment;

FIG. 3 shows a vehicle with the trailer cargo monitoring apparatus according to an embodiment;

FIG. 4 shows a flow chart of a method for monitoring a cargo of a trailer according to an embodiment; and

FIG. 5 shows another flow chart of a method for monitoring a cargo of a trailer according to an embodiment.

### DETAILED DESCRIPTION OF A PREFERRED EXAMPLE EMBODIMENT AND OF THE BEST MODE OF THE INVENTION

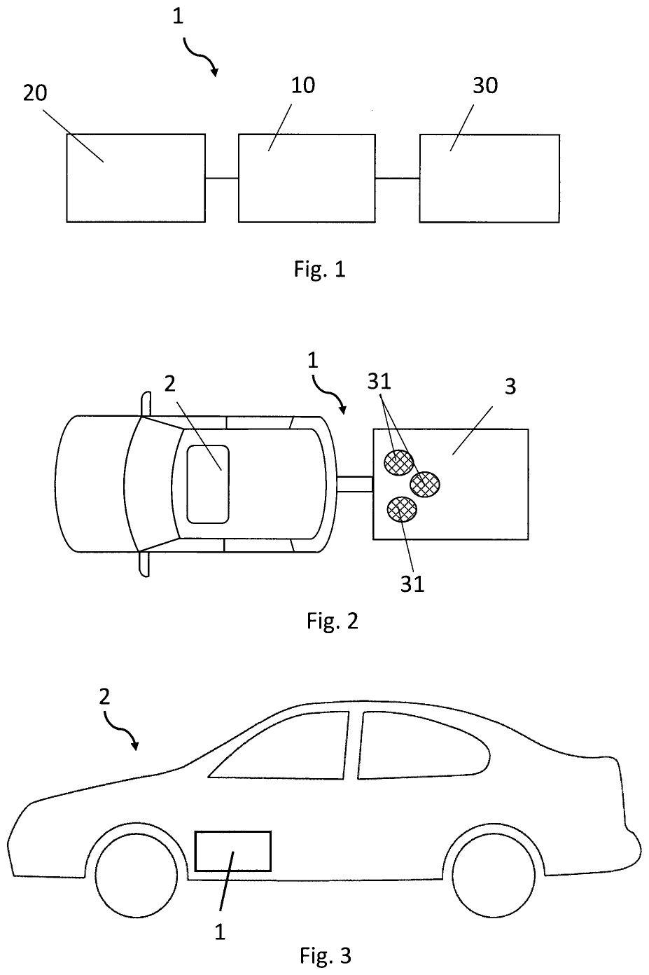

FIG. 1 shows a block diagram of a trailer cargo monitoring apparatus 1. The trailer cargo monitoring apparatus 1 comprises a sensor arrangement 20 and a calculation unit 10. The calculation unit 10 may comprise a processor, a processing circuit, or an electronic calculation circuit as well as a data memory or data storage device. More particularly, for example, the calculation unit 10 may comprise a microprocessor, a microcontroller, a digital signal processor (DSP), an image processor, an application specific integrated circuit (ASIC), a field programmable gate array (FPGA) and/or other such electronic calculation circuits, as well as software for performing the analysis, evaluation and control functions and steps disclosed herein. The calculation unit 10 may be embodied in computer hardware, firmware and/or software. The data memory or data storage device may comprise any electronic, magnetic and/or optical medium for permanently and/or temporarily storing computer data.

Further, the trailer cargo monitoring apparatus may comprise a warning unit 30, such as an indication lamp, a display screen or a user interface. The sensor arrangement 20 may be configured to capture image data of a cargo 31 on or within a trailer 3, which is coupled to a vehicle 2 (see FIG. 2). The sensor arrangement 20 may comprise a camera, for example, a rear view camera of the vehicle, but the sensor arrangement 20 may also comprise a radar, lidar or ultrasonic sensor. The sensor arrangement 20 may be preferably arranged at the rear end of the vehicle 2 facing the trailer 3 with the cargo 31 to be monitored. The sensor arrangement 20 may be configured to capture several images of the cargo on or within the trailer, such as a video or to capture image data in constant time intervals, for example every minute or every ten seconds. For a better view of the cargo and therefore a better monitoring of the cargo, the trailer may be an open trailer, such that the sensor arrangement 20 at the rear end of the vehicle is able to capture image data of the cargo within the trailer. Further, the sensor arrangement 20 may be configured to capture reference image data before the vehicle starts driving. The start of the vehicle may be determined if the velocity of the vehicle becomes greater than 2 m/s which can be detected from the data of the sensor arrangement 20 and/or data of a separate speed sensor of the vehicle.

The calculation unit 10 may be configured to analyze the captured image data and to determine, based on this image data, the actual position of the cargo on or within the trailer. The cargo 31 may be objects, such as furniture, bikes, cement or a combination thereof. By determining the actual position of the cargo or the objects of the cargo, the actual state of the cargo may be monitored, i.e. the position of the cargo and if the cargo is still present and not fallen off the trailer. In other words, the calculation unit 10 may be configured to determine whether or not the state (e.g. presence and position) of the cargo is OK. Further, the calculation unit 10 may be configured to inform or warn the driver if the actual position of the cargo or parts of the cargo differ from a predefined position of the cargo by more than a predefined threshold. The calculation unit 10 may be configured to compare the actual position or the presence of the cargo in the captured image data with the position or the presence of the cargo in the reference image data. If the position of the cargo has changed more than a predefined threshold, e.g. 5 or 10 cm, the driver may be informed or warned via the warning unit 30. The warning unit may be an indication lamp, a display screen or a user interface. Since the trailer cargo monitoring apparatus 1 informs the driver about a position shift of the cargo or a change in the state of the cargo, the driver may be more relaxed when driving and may focus more attention on the traffic, since he does not have to look in the rear view mirror and monitor his cargo.

FIG. 2 shows the vehicle 2 having the trailer cargo monitoring apparatus 1 and the trailer 3, which is coupled to the vehicle 2. Further, some objects 31 are present on or within the trailer 3 on the cargo platform of the trailer 3, wherein these objects 31 define the cargo 31 of the trailer 3. The trailer cargo monitoring apparatus 1 is configured to monitor the cargo 31 by comparing the actual position of the cargo 31 with a predefined or reference position of the cargo 31. If the cargo 31 shifts its position, for example due to a braking or driving maneuver or due to the cargo 31 not having been secured properly, the trailer cargo monitoring apparatus 1 informs or warns the driver about this position shift of the cargo 31. By the use of the trailer cargo monitoring apparatus 1, the driver can be more relaxed while driving and he can focus more attention on the traffic as he does not have to look in the rear view mirror for monitoring his cargo.

FIG. 3 shows the vehicle 2 with the trailer cargo monitoring apparatus 1. Preferably, the sensor arrangement of the trailer cargo monitoring apparatus 1 is located at a rear end of the vehicle 1 and faces backwards to view the trailer to be monitored. In should be noted, that a rear view camera of the vehicle 2 may be used as the sensor arrangement of the trailer cargo monitoring apparatus 1.

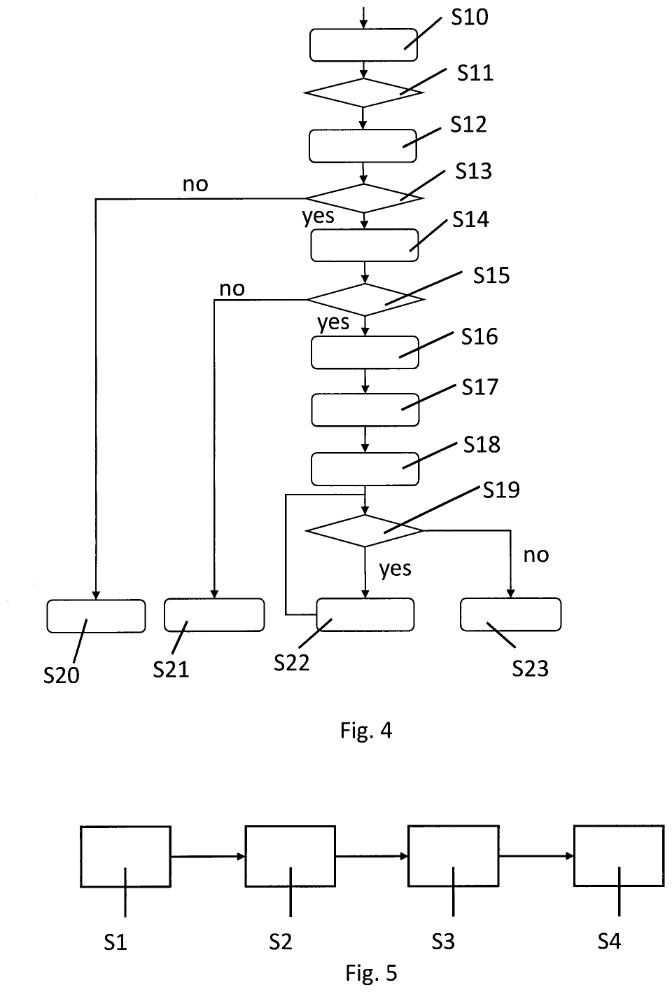

FIG. 4 shows a flow chart of a method for monitoring a cargo of a trailer. In step S10 a vehicle state and the intention of starting a new trip are determined. In step S11, a new trip is recognized if the velocity of the vehicle becomes greater than 2 m/s. Subsequently, in step S12 the presence of a trailer is determined from the sensor data. In step S13, it is decided based on the presence of the trailer, which step should be executed next. If no trailer is present, the method goes to step S20 and it is recognized that no trailer is coupled to the vehicle and the method ends for this trip of the vehicle. If step 13 recognizes the presence of the trailer, the method goes to step S14, in which the trailer position and shape are determined from the sensor image data. In the following step S15 it is determined from the sensor image data if a cargo is visible on or within the trailer. If no cargo is visible, the method goes to step S21 and the method ends for this trip of the vehicle. If the cargo is visible on or within the trailer, the method progresses to step S16 in which objects are detected and recognized as cargo in the sensor image data based on signature features of the objects. In step S17 the initial positions of all cargo objects are stored as reference positions. In step S18 later while driving during this trip, the current actual positions of the cargo objects are determined from the sensor image data. In step S19, the current actual position of the cargo is checked whether it is OK, by comparing it to the reference position of the cargo. If the position has changed, the method goes to step S23, because the state of the cargo is not OK. Then the driver of the vehicle may be informed or given a warning by the cargo monitoring apparatus. If instead the position of the cargo remains the same, i.e. no position shift appears, then the method goes to step S22, in which the cargo state is OK. After step S22, the method goes back to step S18 for again determining the new current actual position of the cargo, and/or directly or after step S18 to step S19 for further monitoring the current actual position of the cargo.

FIG. 5 shows a simplified flow chart of a method for monitoring a cargo of a trailer. In step S1 a sensor arrangement captures image data of the cargo on or within a trailer. Preferably, the trailer is an open trailer and the sensor arrangement is a rear view camera of a vehicle. In step S2 a calculation unit analyzes the captured image data. In particular, the calculation unit identifies the cargo within the trailer and the calculation unit may define a reference image. In step S3, the calculation unit determines the actual position of the cargo in the trailer to monitor the cargo. Further, the calculation unit may compare the actual image data with the defined reference image to determine a position shift of the cargo. In step S4, the calculation unit informs or warns the driver, if the actual position of the cargo differs from the predefined or reference position of the cargo by more than a predefined threshold. In other words, if the position shift of the cargo exceeds the predefined threshold, the drive receives an information via a warning lamp or the driver receives a message via a display screen or a user interface.

Another embodiment of the invention provides a computer program product or element, which, when executed by a processor (e.g. a processor of the calculation unit 10), will cause the inventive method as set forth herein to be executed. The computer program product may be physically, transferably and reproducibly embodied in any computer-readable signal and/or stored in any computer-readable medium. The computer-readable medium may be a non-transient medium or a non-transitory medium. The term “non-transitory” should be understood to mean existing for more than only a brief fleeting instant, but not necessarily requiring permanence. Alternatively, the term “non-transitory” should be understood to be a characteristic of the medium itself, and is not a limitation of the duration or persistence of the computer-readable data or instructions. A non-transitory computer-readable medium thus includes, for example, all magnetic, optical and/or electronic, tangible or physical media for permanently or temporarily storing computer-readable instructions and/or data, for example CDs, DVDs, flash drives, all forms of RAMs, all forms of ROMs, hard drives and solid state memories.

Although the invention has been described with reference to specific example embodiments, it will be appreciated that it is intended to cover all modifications and equivalents within the scope of the appended claims. It should also be understood that the present disclosure includes all possible combinations of any individual features recited in any of the appended claims. The abstract of the disclosure does not define or limit the claimed invention, but rather merely abstracts certain features disclosed in the application.

What is claimed is:

1. A trailer cargo monitoring apparatus for a vehicle, comprising:
a sensor arrangement; and
a calculation unit;
wherein the sensor arrangement is configured to capture actual image data of a cargo within a trailer coupled to the vehicle;
wherein the calculation unit is configured to analyze the actual image data and based thereon to determine an actual position of the cargo so as to monitor the cargo,
wherein the calculation unit is configured to compare the actual position of the cargo with a predefined position, and
wherein the calculation unit is configured to inform a driver of the vehicle when the actual position of the cargo differs from the predefined position by more than a predefined threshold.

2. The trailer cargo monitoring apparatus according to claim 1, wherein the sensor arrangement is arranged at a rear end of the vehicle facing toward the trailer.

3. The trailer cargo monitoring apparatus according to claim 1,
wherein the sensor arrangement is configured to capture reference image data of the cargo on or within the trailer before or when the vehicle starts driving, and
wherein the calculation unit is configured to determine the predefined position from the reference image data, and to determine a position shift of the cargo by the comparing of the actual position with the predefined position.

4. The trailer cargo monitoring apparatus according to claim 1, wherein the sensor arrangement comprises a camera.

5. The trailer cargo monitoring apparatus according to claim 1, wherein the trailer is an open trailer.

6. The trailer cargo monitoring apparatus according to claim 1, further comprising an indication lamp, a display screen and/or a user interface, via which the calculation unit is configured to inform the driver when the actual position of the cargo differs from the predefined position by more than the predefined threshold.

7. A combination comprising a vehicle and the trailer cargo monitoring apparatus according to claim 1 mounted on the vehicle.

8. A method of monitoring a cargo on or within a trailer, comprising:
capturing, by a sensor arrangement, image data of the cargo within the trailer;
analyzing, by a calculation unit, the image data;
determining, from the image data by the calculation unit, an actual position of the cargo so as to monitor the cargo;
comparing, by the calculation unit, the actual position of the cargo with a predefined position; and
informing, by the calculation unit, a driver of the vehicle when the actual position of the cargo differs from the predefined position by more than a predefined threshold.

9. A computer program element for controlling a trailer cargo monitoring apparatus, which when executed by a processor of the trailer cargo monitoring apparatus causes the method according to claim 8 to be performed by the trailer cargo monitoring apparatus which includes the sensor arrangement and the calculation unit.

10. A non-transitory computer-readable medium, on which is stored a computer program including instructions, which when executed by a processor cause the method according to claim 8 to be performed.
